(19) United States
(12) Patent Application Publication
(10) Pub. No.: US 2026/0202723 A1
(43) Pub. Date: Jul. 16, 2026

(54) AN IMPROVEMENT IN A PROJECTION DEVICE

(71) Applicant: AL-KOR MAKINA KALIP SANAYI VE TICARET A.S., Arnavutkoy, Istanbul (TR)

(72) Inventors: Erol DIVANYAN, Arnavutkoy, Istanbul (TR); Yasin CAGLAYAN, Arnavutkoy, Istanbul (TR); Sercan MARAZYAN, Arnavutkoy, Istanbul (TR); Ali DONMEZ, Arnavutkoy, Istanbul (TR); Baris ISPIR, Arnavutkoy, Istanbul (TR)

(21) Appl. No.: 19/131,333

(22) PCT Filed: Nov. 15, 2023
(86) PCT No.: PCT/TR2023/051332

§ 371 Date: May 20, 2025

(30) Foreign Application Priority Data
Dec. 21, 2022 (TR) 2022/019932

(51) Int. Cl. G03B 21/16; G03B 21/14; G03B 21/20; G03B 21/54

(52) U.S. Cl. CPC G03B 21/16; G03B 21/145; G03B 21/2053; G03B 21/54

(57) ABSTRACT

A projection device has housing and an optical group positioned within the housing, an electronic board in connection with the housing and including a power input, a light source and an optical body centering slot, and a cooler cover in connection with the electronic board and the housing. The cooler cover includes a structure of transverse fins of a polycarbonate or polyamide-based plastic material with high thermal conductivity and longitudinal fins of a polycarbonate or polyamide-based plastic material with high thermal conductivity.

### SUBJECT OF THE INVENTION AND TECHNICAL FIELD

The invention relates to a lighting assembly used especially in the automotive industry. The present invention relates to an improved device in a projection system, preferably in the automotive sector, which is placed under the doors or at the bottom of the mirrors of a vehicle, which increases the brand recognition of the vehicle and provides lighting when the light is insufficient.

### STATE OF THE ART

With the developments in the field of technology in recent years, many innovations have been made in projection devices that work on the principle of filtering light by using electronic and optical equipment through video signals received from an external source (computer, television, etc.) thanks to the lamp (light source) contained therein, or creating an image by changing the polarization. The quality of the projected image is improved with the lenses used.

Apart from projecting the image with signals from an external source, projection devices are also used for purposes such as advertising and lighting by using a light source and lenses to project only light or an illuminated visual element on a surface. With the developing technology, it is known that some problems are encountered in the electronic circuit board section after the projection devices project the image.

In the state of the art, the electronic boards used in the projection devices generate heat, and the resulting heat builds up temperature on the electronic circuit. In order to remove mentioned heat and temperature from the electronic board and circuit, the use of extra cooler is required.

In the state of the art, aluminum or copper-derived alloy metals with high thermal conductivity are used in the cooling systems to remove the heat generated in the electronic boards of projection devices from the system, but due to the thin-walled structure of the part, mold filling problems are also encountered in metal injection systems of metal-derived materials in the designs.

In the state of the art, the high specific weight of the metal or aluminum cooling material in the cooling systems of the projection devices and the filling problems increase the production cost of the materials.

In the state of the art, with the use of aluminum or metal cooling material in the cooling systems of projection devices, the high heat cannot be removed from the part, thus the deformations that will occur in the part cannot be prevented, which leads to a decrease in optical and electronic values.

In the state of the art, the high specific weight of aluminum or metal cooling material in the cooling systems of the projection devices increases the total weight of the parts.

In the state of the art, the expansion coefficient of the parts using aluminum or metal cooling material in the cooling systems of the projection devices is high compared to the plastic part to which it is mounted, thereby causing deformations on the part.

In the state of the art, with the use of plastic cooler in the cooling systems of the projection devices, different elongation values occur in the part due to different expansion rates and because of these differences, fractures and cracks occur due to additional stress on the parts.

In the state of the art, fractures and cracks occur due to the fact that the thermal expansion coefficient of the plastic cooler in the cooling systems of the projection devices is not close to the plastic body to which it is mounted.

In the state of the art, the use of aluminum or metal coolers in the cooling systems of the projection devices makes it difficult to control the high temperature generated on the electronic circuit board. The flexible structure of the plastic material makes it easier to control the high temperature generated on the electronic circuit board.

In the state of the art, Al-Kor Makina Kalip Sanayi ve Ticaret A.Ş. has an application no. 2018/10651 for a projection device. However, this application is a utility model application that aims to reflect the logo on the ground and to increase the definition quality of the projected image by calculating the forms of the lenses and the distances between them, and to make it perceptible by drivers and passengers, but aluminum, metal or plastics with lower conductivity used in the state of the art are used in the cooler cover part. Our new application includes the improvements made in the cooler cover part of our previous utility model no. 2018/10651.

The U.S. patent application no. US2017329210 describes a logo projection device in which light emitted from a light source is projected onto a surface by passing through lenses with holes, each of which is designed to form different parts of the logo. The said patent does not describe the improvement made to the cover of the logo projection device.

The Chinese utility model application no. CN208832252U describes an improvement made to the spotlights of led lamps. The said utility model describes that the plate through which the light is transmitted can be glass or plastic, but does not specify which plastic material is used in what way and how it provides an advantage. In this aspect, it differs from our invention.

The Chinese patent application no. CN203211185 describes a logo projection device containing 3 lenses with different drawer inputs that allow changing the size of the image to be created.

The German patent with application no. DE202011000429 describes a projection device with a laser system constructed using a light source and a lens.

As can be seen from the above-mentioned patents, there are various patent applications for reflecting a logo and providing lighting in the state of the art. However, the applications does not describe coolers developed by using plastic materials with thermal conductivity to conduct heat.

### Technical Problems to be Solved by the Invention

The object is to provide ease of use in the production and assembly stage by reducing the part production costs and also increasing the efficiency of the material with the use of raw materials containing plastic cooler instead of using aluminum, copper or metal raw materials in the cooler covers of the projection device according to the invention.

In the state of the art, it is aimed to remove the heat on the electronic circuit board by using a plastic cooler in the cooling systems of the projection devices.

In the cooler covers of the projection device according to the invention, it is aimed to provide heat transfer conduction by using a material with high thermal conductivity compared to commonly used aluminum, metal or plastic materials.

In the cooler covers of the projection device according to the invention, it is aimed to increase the efficiency by transmitting the high heats on the part to the environment by using a material with high thermal conductivity compared to commonly used aluminum, metal or plastic materials.

In the cooler covers of the projection device according to the invention, it is possible to reduce the cost in production, assembly and sales by reducing the weight of the part by using raw materials containing a plastic cooler instead of aluminum, metal or copper-derived alloy metals.

In the state of the art, it is aimed to prevent the stress formation that may occur on the parts by balancing the elongation values that occur in the part due to different expansion rates by using a plastic cooler in the cooling systems of the projection devices.

In the state of the art, this will be prevented due to the fact that the thermal expansion coefficient of the plastic cooler of the projection devices is close to the plastic body to which it is mounted.

Another advantage of the cooler cover of the projection device according to the invention is that the cooler cover can be easily replaced on demand and as required.

A further advantage of the cooler cover of the projection device according to the invention is that the heat emitted from the selected light source to reach the desired level of lighting will be removed without damaging the optical, mechanical and electronic system.

Figures are to be used for a better understanding of the projection device according to the invention.

### DESCRIPTION OF THE FIGURES

FIG. 1: Shows a perspective image of the projection device according to the invention, viewed from the right side.

FIG. 2: Shows a projection image of the cooler cover of the projection device to be produced from plastic material according to the invention, viewed from the opposite side.

FIG. 3: Shows a perspective image of the body of the projection device according to the invention, viewed from the front side.

FIG. 4: Shows a perspective image demonstrating the electronic board on the cover of the projection device according to the invention.

FIG. 5: Shows a perspective detail image of the cooler cover of the projection device produced from plastic material according to the invention.

FIG. 6: Shows a perspective image demonstrating the optical part on the projection device according to the invention.

### REFERENCE NUMBERS OF THE PORTIONS AND PARTS TO HELP DESCRIBE THE INVENTION

1—Projection device
   1a—Cooler cover
   1c—Vehicle mounting snap
   1d—Housing
   1e—Cooler cover lock
   1f—Cooler cover cavity
   1g—Transverse fin
   1h—Longitudinal fin
   1i—Housing lock
   1j—Housing protrusion
   1k—Optical group
   1m—Power supply input
2—Electronic board
   2a—Power input
   2b—Light source
   2c—Optical body centering slot

### DETAILED DESCRIPTION OF THE INVENTION

With the improvement made in the projection device according to the invention, the use of plastic materials instead of metal materials in the cooler covers prevents additional stress formation due to thermal expansion, thereby creating an assembly that will allow for increased efficiency by eliminating deformation on the part and reducing the temperature on the electronic board. The aim of the mentioned projection devices is to reduce the production cost of the cooler covers obtained by using plastic materials instead of materials such as metal, aluminum, etc. in the cooler covers to meet the cooling needs of the electronic boards in the projection devices.

With the improvement made in the projection device according to the invention, cracks or fractures are prevented, which occur as a result of the tension effect on the cooler cover after the electronic board is heated due to the different elongation coefficients of the elements such as metal, aluminum, etc. against temperature in the cooler covers in the state of the art.

The heat transfer conduction is increased by using a cooler material made of polycarbonate or polyamide-based raw materials with high thermal conductivity instead of metal or aluminum material in the cooler covers of the projection device according to the invention, and therefore the efficiency is increased by transferring the heat generated to the environment in a better way.

The mentioned design can be a design as seen in the figures for a better understanding of the subject, or it can have different geometries and different dimensions while maintaining the technical elements. The figures used in the invention are only intended to give an idea and should not be binding.

The projection device according to the invention is designed to be used in an automobile as well as in buses, trucks and other groups of automotive vehicles. The mentioned design can also be integrated into aircraft and marine vessels.

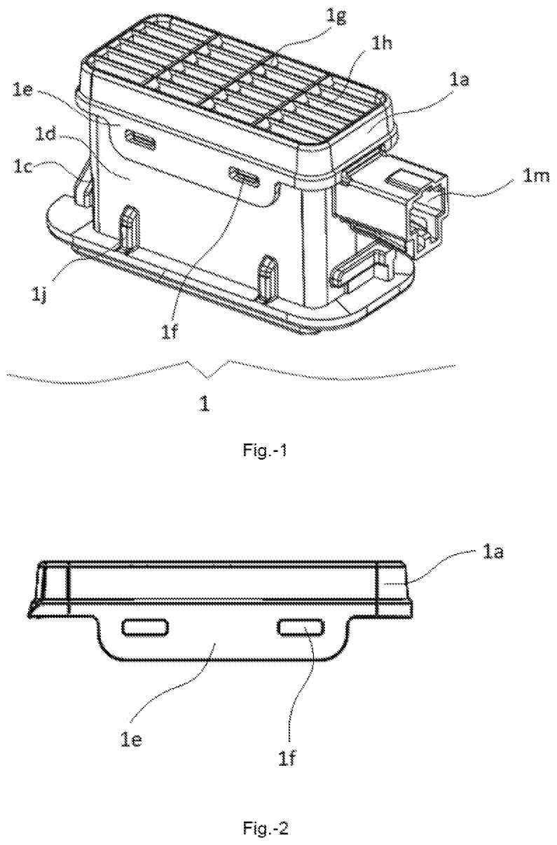

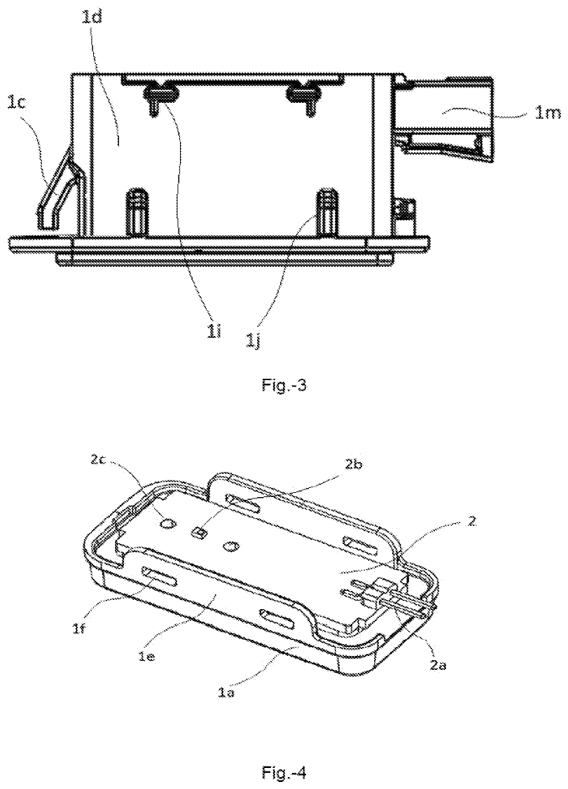

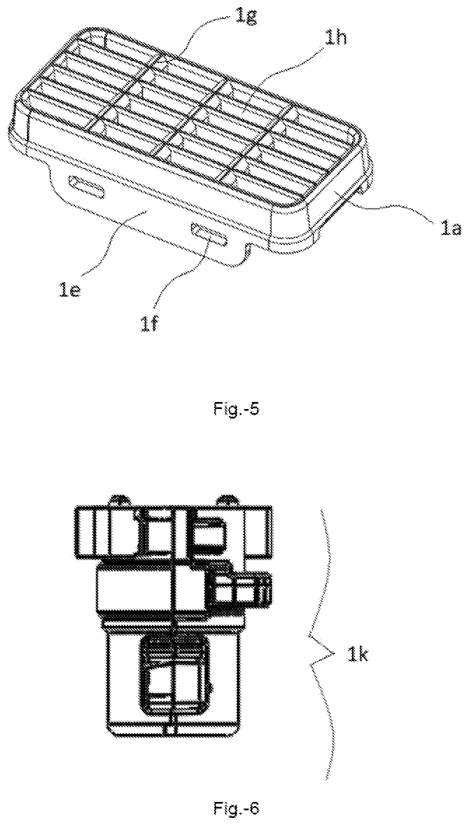

The elements contained in the projection device according to the invention are generally seen from different perspectives in FIG. 1, FIG. 2, FIG. 3, FIG. 4, FIG. 5, FIG. 6.

The projection device (1) according to the invention comprises, as seen in the perspective images in FIG. 1 and FIG. 3 in general, a housing (1d) and an optical group (3) positioned within mentioned housing (1d), an electronic board (2) in connection with mentioned housing (1d) and comprising a power input (2a), a light source (2b) and an optical body centering slot (2c), a cooler cover (1a) in connection with said electronic board (2) and mentioned housing (1d), characterized in that the said cooler cover (1a) comprises transverse fins (1g) and longitudinal fins (1h) for heat transfer. The mentioned transverse fin (1g) and longitudinal fin (1h) are made of polycarbonate or polyamide-based plastic material with high thermal conductivity. The function of these fins is to increase the heat transfer surface. Since the heat transfer surface is increased in the sections formed by the transverse fin (1g) and longitudinal fin (1h) in the said cooler cover (1a), heat distribution is better realized, increasing the efficiency of the part.

In the projection device (1) according to the invention, the housing (1d) as seen in FIG. 1 and FIG. 3 comprises a cooler cover (1a) which is detachable in FIG. 1, FIG. 4 and FIG. 5. An electronic board (2) with the power input (2a), light source (2b) and optical body centering slot (2c) is located under the mentioned cooler cover (1a). The cooler cover (1a) comprises at least one transverse fin (1g) and longitudinal fin (1h) at the top to prevent damage to the electronic board (2) by heat during circuit operation. The cooler cover (1a) of the said projection device (1) may have at least one transverse fin (1g) and at least one longitudinal fin (1h), or may have only transverse fins (1g) or only longitudinal fins (1h). In the said transverse fin (1g) or longitudinal fin (1h) structure, instead of the product used as a cooler made of aluminum and metal material in the cover that is connected to the LED and electronic circuit board in the state of the art, a cooler material made of a polycarbonate or polyamide-based raw material with high thermal conductivity is used.

The mentioned cooler cover (1a) is attachable and detachable for easy access to the housing (1d). The inner corrugated structure of the edges of the said housing (1d) and the circumferential skirted form of the said cooler cover (1a) prevent the entry of damaging elements such as liquid and dust into the projection device (1) after the assembly process. The cooler cover (1a) comprises at least two cooler cover locks (1e) as seen in FIG. 1, FIG. 4 and FIG. 5, and the mentioned cooler cover lock (1e) is compatible with the housing lock (1i) located on the housing (1d) as seen in FIG. 3, and they enable the fixing process by engaging each other as a protrusion and a slot. The process of engaging the housing lock (1i) and the cooler cover lock (1e) is carried out through the cooler cover cavity (1f) in the cooler cover lock (1e). In addition, the projector comprises a vehicle mounting snap (1c), which looks like a nail, for attaching and detaching from the vehicle in which it is positioned and at least two housing protrusions (1j) on the vehicle side to prevent it from moving around in the slot to which it is attached. It comprises a lens cavity that allows the light from the light source (2b) to pass through. The energy required for the operation of the electronic board (2) is preferably supplied from the source where the projection device (1) is fixed, and the housing (1d) comprises a power supply input (1m) to transfer the energy to the electronic board (2) as seen in FIG. 1 and FIG. 3. The electronic board (2) comprises a power input (2a) to transfer the energy coming to the power supply input (1m) to the electronic board (2).

In the projection device (1) according to the invention, a cylindrical inner body is placed inside the housing (1d) and the electronic board (2) containing the light source (2c) is placed on it.

### INDUSTRIAL APPLICABILITY OF THE INVENTION

The projection device (1) according to the invention is placed under the doors or mirrors of passenger automobiles, motorcycles, bicycles, buses, trucks and commercial vehicles or any other desired part and is suitable for lighting and visual presentation when the door of the vehicle is opened.

1. A projection device; comprising a housing and an optical group positioned within said housing, an electronic board in connection with said housing and comprising a power input, a light source and an optical body centering slot, a cooler cover in connection with said electronic board and said housing, wherein said cooler cover comprises a structure of transverse fins of a polycarbonate or polyamide-based plastic material with high thermal conductivity and longitudinal fins of a polycarbonate or polyamide-based plastic material with high thermal conductivity.

2. A projection device according to claim 1, wherein the cooler cover of the projection device has at least one transverse fin and at least one longitudinal fin, or only transverse fins or only longitudinal fins.

3. A projection device according to claim 1, wherein the cooler cover is detachable from the housing.

4. A projection device according to claim 2, wherein the light source of the electronic board is positioned at the bottom of the cooler cover within the housing.

5. A projection device according to claim 3, wherein the electronic board is switchable in order to increase or decrease the luminous intensity of the light source.

6. A projection device according to claim 2, wherein the cooler cover has a circumferential skirted form and the housing has an inner corrugated form.

7. A projection device according to claim 1, comprising at least one vehicle mounting snap positioned on the housing of the projection device.
